(19) United States
(12) Patent Application Publication
(10) Pub. No.: US 2008/0276579 A1
(43) Pub. Date: Nov. 13, 2008

(54) DOUBLE CHAIN FOR A WESTERN BIT

(76) Inventor: Karin Deffner, Fischbachau (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(21) Appl. No.: 11/931,055

(22) Filed: Oct. 31, 2007

Related U.S. Application Data
(60) Provisional application No. 60/865,021, filed on Nov. 9, 2006.

(30) Foreign Application Priority Data
Jun. 9, 2007 (EP) 07 017 482.6

(51) Int. Cl. B68B 1/04; F16G 13/16

(52) U.S. Cl. 54/6.1; 59/84

(57) ABSTRACT

A double chain in one example includes two chains lying flatly adjacent to each other, where the chains have chain elements turned out to the right and respectively to the left, which are securely connected with each other at one location.

### REFERENCE TO RELATED APPLICATIONS

This application claims the benefit of the filing date of European Patent Application No. 07 017 482.6 filed Jun. 9, 2007 and of U.S. Provisional Patent Application No. 60/865,021 filed Sep. 11, 2006, the disclosure of which applications is hereby incorporated herein by reference.

### FIELD OF THE INVENTION

The field relates to a double chain for a Western bit.

### BACKGROUND OF THE INVENTION

Western bits of the curb type, such as for example, Western curbs and the so-called “bits and shanks” are particular curb bridle arrangements which have developed in Western riding. Bridle arrangements of the curb type operate with a lever action which results from the cooperation of the extensions (levers) mounted on the bit and a curb chain.

The curb chains which are usually used for curbs are chains in a single piece which are to be turned out to the right, of the double round curb-chain type. The curb-chain is a type of chain which is known in jewellery manufacture, belonging to the so-called loop chains (or open-link chains). The basic type of loop chain is the chain cable, in which horizontal and vertical loops alternate. In contrast to this, the curb chain consists of uniformly flat loops or links, namely round or oval loops or links which are turned towards the right. The turning of the individual links causes the entire chain to have one turning direction.

In detail, a chain turning out to the right may consist of links which, in contrast to normal flat, round or oval shaped chain links (such as for example, in a chain cable), are formed such that in the turned-out state, they rotate around each other reciprocally or fit snugly into each other and thereby make it possible that the adjacent chain links do not stand perpendicularly to each other under tensile stress (as in the chain cable, which is arranged from alternate vertical and horizontal links), but rather lie as flat as possible, ideally in a line adjacent to each other. Thereby, a chain having a flat surface, ideally with a width which corresponds to the width of the links and, lying flat adjacent to each other and flexibly in all directions can adapt itself to a round surface, such as for example, the chin of a horse. In jewellery manufacture, a further differentiation is made between flat curb-chains and round curb-chains.

In the maximum flat state, and hence in the maximum state turned out to the right, i.e. in a state which is twisted in itself at a maximum in a turning to the right, the chain can not be further twisted in itself towards the right. This means that the chain blocks itself against a further turning to the right and is therefore closed in this direction. In a turning to the left, the chain opens but, in so doing, leaves its maximum flat state. If the chain ends are fixed in the turned-out state, as is the case when the chain is suspended in the curb in the turned-out state, the chain can no longer turn and retains its flat, turned-out state. Depending on how that links of the chain are formed, the chain can also be over-turned over the maximum flat and turned-out state, i.e., it can twist further in itself. Within the framework of the double chain, the turned-out state means that the chain is flat at a maximum, i.e., in that case is not over-turned.

However, these curb chains, the interlinking of the individual links of which is directed identically over the entire chain length, may bring about an unequal tension on the two sides of the curb bit. Through this different action of force, a different lever action may be achieved on the curb bit bar in the horse's mouth. More pressure may be exerted to the right than to the left on the toothless part of the lower jaw and on the lip. The unequal tension may also bring it about that the left-hand curb chain hook is drawn away from the horse's mouth and the right-hand curb chain hook is drawn towards the horse's mouth. At the same time, the effects on the horse's mouth by the different lever action on the curb bit bar more pressure on the toothless part of the lower jaw and on the lip to the right than to the left is to be taken into consideration. This may lead to tongue defects, such as for example, a pushing out of the tongue. Also, effects on the right-hand corner of the mouth by the tension inwards on the right-hand curb chain hook are to be observed. This may frequently be observed in a lip hanging on one side on the right-hand side of the horse's mouth. Moreover, this may frequently lead to injuries at the corner of the mouth.

WO 2006/089745 describes a curb chain in two parts, particularly for use in dressage curb bits, which has a first and a second chain element, in which in the first and the second chain element, the chain links are interlinked respectively in opposite directions (turning out to the left, and turning out to the right). It is described that in this way a force which is exerted onto the curb chain is directed off evenly onto the left- and right-hand sides of the curb bit. Thereby, a different lever action on one side, namely the increased pressure toward the right onto the curb bit bar, is ruled out. Moreover, the tension inwards onto the right-hand curb chain hook is thereby equalized or counteracted. This curb chain advantageously counteracts a lip hanging on one side, injuries to the corner of the mouth and tongue defects. The content of this application is herewith incorporated in its entirety by reference in the disclosure content of this application.

### SUMMARY OF THE INVENTION

A double chain, comprises a first chain 1 and a second chain 2 arranged flatly adjacent to each other, in which chain 1 has at least one first chain element turning out to the left, and chain 2 has at least one second chain element turning out to the right, in which the at least one chain element turning out to the left and the at least one chain element turning out to the right are of equal length and are arranged substantially parallel to each other, and are securely connected with each other at least one location. For example, in FIG. 2, chain element 11 turns out to the left, and chain element 22 turns out to the right. A chain may consist of one or more chain elements and each chain element may consist of one or more links, which include chain links and end links.

In another example, a double chain comprises a first chain 1 and a second chain 2 arranged flatly adjacent to each other, in which chain 1 has at least one first chain element 11 turning out to the left and chain 2 has at least one second chain element 22 turning out to the right, in which the at least one chain element 11 turning out to the left and the at least one chain element 22 turning out to the right are of equal length and are arranged substantially parallel to each other, in which the respective end links 113 and 223 and also 112 and 222, coming to lie adjacent to each other, of the two chains 1 and 2 are united by a further ring 3 and 4 respectively.

In an embodiment, the chains 1 and 2 of the double chain respectively a chain element 12 and respectively a chain element 22 turning out to the right and a chain element 11 and respectively, a chain element 21 turning out to the left, in which the chain element 12 and the chain element 21 and also the chain element 11 and the chain element 22 are of equal length and are arranged substantially parallel adjacent to each other, or alternatively, the chain element 12 and the chain element 22 and also the chain element 11 and the chain element 21 are of equal length and are arranged substantially parallel adjacent to each other.

Also the double chain relates to curb chains for Western bits. Western bits comprise the types of bits and bridle arrangements which are used in Western riding and which have curb chains. Examples of such Western bits are the so-called “bits and shanks” and the Western curb bits.

### BRIEF DESCRIPTION OF THE FIGURES

FIG. 1 shows an embodiment of the double chain.

FIG. 2 shows an embodiment of double chain.

### DETAILED DESCRIPTION OF EXEMPLARY EMBODIMENTS

The examples described and drawings rendered are illustrative and are not to be read as limiting the scope of the invention as it is defined by the appended claims.

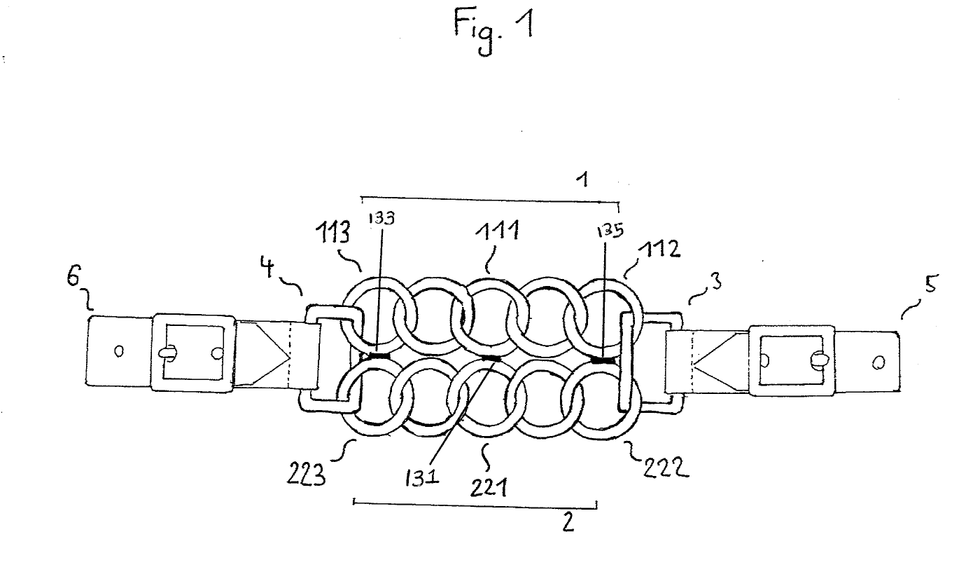

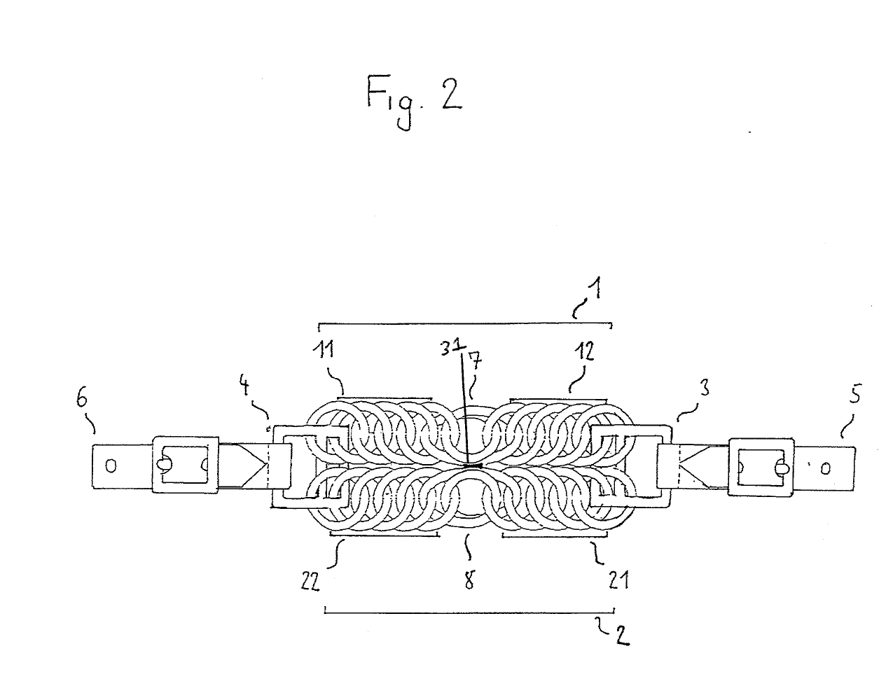

FIG. 1 shows a double chain, comprising two individual chains 1 and 2, in which chain 1 turns out to the left and chain 2 turns out to the right. The two chains are united by the rings 3 and 4 which engage into the end links 113, 223 and also 112 and 222. Preferably, the two chains 1 and 2, as shown in FIG. 1, are of equal length and have the same number of chain links. In addition, the two chains, as shown in FIG. 1, are securely connected with each other by soldering or gluing of particular chain links. In one example, the two chains are securely connected with each other at points 131, 133 and 135. In another example, they may be secured at one location at point 31, for example, as shown in FIG. 2.

By arranging the chains adjacent to each other with a different turning direction, a plane of symmetry is produced along the double chain. Through this symmetry, the forces acting on the chain ends are equalized and the disadvantage of the conventional chains, only turning out to the right, may be avoided.

Here, the end chain links 113, 223, 112 and 222 or the chain links 111 and 221 situated in the center and also, as shown in FIG. 1, all the links in pairs 113, 223, 111, 221 and 112 and 222 can be securely connected with each other. The connection can be brought about for example, by soldering or gluing. Through these connection points in this example, the chain is given further stability.

The double chain may be provided with straps 5 and 6 which engage into the two outer rings 3 and 4. By means of such straps, the connection to the Western bit can be produced. Such straps may be nylon straps, leather straps, cables or cords.

Depending on the purpose of use and the size requirements connected therewith, the double chain between the end links 113 and 223 respectively and 112 and 222 respectively are between 6 cm and 14 cm and 8 cm and 12 cm long, respectively. For example, between 5 and 13 and respectively 7 and 11 chain links are used for this for the individual chains.

FIG. 2 describes another embodiment of the double chain, in which two chains are processed to form a double chain, in which the individual chains comprise respectively a chain element turning out to the right and a chain element turning out to the left. The chain shown in FIG. 2 is formed such that respectively, a chain element turning out to the right comes to lie adjacent to a chain element turning out to the left and therefore, a maximum symmetry and equalization of forces is achieved. In addition, FIG. 2 shows a further specific development of the chain elements, in which a chain link respectively encompasses not only the next chain link, but also the next-but-one chain link. In so doing, a denser chain is produced as for example in FIG. 1, in which a chain link respectively only engages into the next chain link. Both chain types can be used according to requirements. Even denser chains may also be used, if desired.

As an alternative to the embodiment shown in FIG. 2, in another example (not shown), two identical chains 1 and 2 may also be used, and a chain link turning out to the left is arranged respectively parallel to a chain link turning out to the right, but instead a chain link 11 turning out to the left is associated with a chain link 21 turning out to the left, and accordingly then in turn, a chain link 22 turning out to the right is associated with the chain link 12 turning out to the right. A sufficient equalization of forces is produced through the symmetry of the individual chains.

In double chains which respectively comprise two individual chains, which in turn comprise two chain elements of different turning directions, connecting links 7, 8 are used, in order to make possible the reversal of the turning direction in the middle of the chains. The international application WO 2006/089745 which was already mentioned in the introduction shows multiple possibilities as to how such connecting elements can be developed. With regard to these possibilities, in one example, reference is to be made specifically to the disclosure of WO 2006/089745. It is pointed out in particular, that the connecting elements shown in FIG. 2 are only by way of example.

In addition, it is also to be noted with regard to FIG. 2, that corresponding to the higher density of the chain by the engagement of a link into further two links, the end rings 3 and 4 are also specifically developed so that they likewise can engage into two rings instead of one ring, as shown in FIG. 1. The remaining construction of the chain with the straps can correspond to the construction in FIG. 1. With regard to the description, we refer to the corresponding passages of text concerning FIG. 1.

In addition to the double chain per se which has just been described, the double chain further relates to the use of such a double chain for a Western bit and such a Western bit with a double chain according to one example may be realized.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

Alternative combinations and variations of the examples provided will become apparent based on this disclosure. It is not possible to provide specific examples for all of the many possible combinations and variations of the embodiments described, but such combinations and variations may be claims that eventually issue.

What is claimed is:

1. A double chain, comprising
a first chain and a second chain arranged flatly adjacent to each other, wherein the first chain has at least one first chain element turning out to the left and the second chain has at least one second chain element turning out to the right, and
wherein the at least one first chain element turning out to the left and the at least one second chain element turning out to the right are of equal length and are arranged parallel to each other and are connected securely with each other at least one location.

2. A double chain, comprising
a first chain and a second chain arranged flatly adjacent to each other, wherein the first chain has at least one first chain element turning out to the left and the second chain has at least one second chain element turning out to the right, and
wherein the at least one first chain element turning out to the left and the at least one second chain element turning out to the right are of equal length and are arranged parallel to each other, wherein first and second end links respectively and third and fourth end links respectively coming to lie adjacent to each other, of the two first and second chains, are united by respectively a first ring and second ring.

3. The double chain according to claim 1, wherein the at least one first chain element turning out to the left and the at least one chain element turning out to the right are securely connected with each other laterally by fifth and sixth chain links respectively, which are centrally arranged in the chain elements.

4. The double chain according to claim 1, wherein the at least one first chain element turning out to the left and the at least one second chain element turning out to the right are securely connected with each other laterally at two locations by two chain links respectively.

5. The double chain according to claim 1, wherein the at least one first chain element turning out to the left and the at least one second chain element turning out to the right are securely connected with each other laterally at three locations by three chain links respectively arranged in the chain elements centrally and at the ends.

6. The double chain according to claim 1, wherein links are connected with each other are soldered or glued.

7. The double chain according to claim 1, wherein end links of the first and second chains, the end links respectively coming to lie adjacent to each other, are united by a first ring and second ring respectively.

8. The double chain according to claim 7, wherein the first and second rings are held by two first and second straps respectively, wherein the two straps have a buckle and a corresponding hole pattern, such that a connection to a Western bit can be brought about.

9. The double chain according to claim 8, wherein the first and second straps are leather straps, nylon straps, cables or cords.

10. The double chain according to claim 1, wherein a measurement from a first end link and a second end link respectively to a third end link and a fourth end link respectively has a length between 6 cm and 14 cm or between 8 cm and 12 cm.

11. The double chain according to claim 1, wherein the first and second chains respectively comprise between 5 and 13 or between 7 and 11 chain links.

12. The double chain of claim 1, wherein:
the first chain has a third chain element turning out to the right;
the second chain has a fourth chain element turning out to the left; and
the first chain element, the second chain element, the third chain element and the fourth chain element being disposed such that:
the first chain element is of an equal length and arranged adjacent to one of the second chain element or the fourth chain element, and the third chain element is of an equal length and arranged adjacent to the other of the fourth chain element or the second chain element, respectively.

13. The double chain according to claim 12, wherein the third chain element turning out to the right and the first chain element turning out to the left are connected with a first connecting element, and the fourth chain element turning out to the left and the second chain element turning out to the right are connected with a second connecting element.

14. The double chain according to claim 13, wherein the first and second connecting element are rings.

15. The double chain according to claim 14, wherein the first and second connecting elements are constructed such that a chain element connected therewith turning out to the right, and a chain element turning out to the left come to lie flatly in one plane.

16. The double chain according to claim 15, wherein the chains are securely connected with each other using the first and second connecting elements respectively.

17. A method comprising: using the double chain of claim 1, as a curb chain for a Western bit.

18. A Western bit comprising a double chain according to claim 1.

19. The double chain according to claim 2, herein the at least one first chain element turning out to the left and the at least one chain element turning out to the right are securely connected with each other laterally by a fifth and sixth chain links respectively, which are centrally arranged in the chain elements.

20. The double chain according to claim 2, wherein the at least one first chain element turning out to the left and the at least one second chain element turning out to the right are securely connected with each other laterally at two locations by two chain links respectively.

21. The double chain according to claim 2, wherein the at least one first chain element turning out to the left and the at least one second chain element turning out to the right are securely connected with each other laterally at three locations by three chain links respectively arranged in the chain elements centrally and at the ends.

22. The double chain according to claim 2, wherein the first and second rings are held by two first and second straps respectively, wherein the two straps have a buckle and a corresponding hole pattern, such that a connection to a Western bit can be brought about.

23. The double chain according to claim 2, wherein a measurement from a first end link and a second end link respectively to a third end link and a fourth end link respectively has a length between 6 cm and 14 cm or between 8 cm and 12 cm.

24. The double chain according to claim 2, wherein the first and second chains respectively comprise between 5 and 13 or between 7 and 11 chain links.

25. The double chain according to claim 2, the first chain has a third chain element turning out to the right; the second chain has a fourth chain element turning out to the left; and the first chain element, the second chain element, the third chain element and the fourth chain element being disposed such that:
the first chain element is of an equal length and arranged adjacent to one of the second chain element or the fourth chain element, and the third chain element is of an equal length and arranged adjacent to the other of the fourth chain element or the second chain element, respectively.
